(19) United States
(12) Patent Application Publication
(10) Pub. No.: US 2018/0107826 A1
(43) Pub. Date: Apr. 19, 2018

(54) TECHNIQUES FOR TRUSTED APPLICATION FUZZING MITIGATION

(71) Applicant: QUALCOMM Incorporated, San Diego, CA (US)

(72) Inventor: Paul ELLIS, San Diego, CA (US)

(21) Appl. No.: 15/297,066

(22) Filed: Oct. 18, 2016

(51) Int. Cl. G06F 21/57; G06F 21/53

(52) U.S. Cl. CPC G06F 21/577; G06F 21/53

(57) ABSTRACT

Techniques for mitigating attacks on an application operating in a trusted execution environment of a computing device are provided. An example method according to these techniques includes monitoring performance of the trusted application operating in the trusted execution environment of the computing device, determining whether an undesired behavior of the trusted application has occurred more than or equal to a threshold number of times, and executing a delayed restart process for the trusted application.

### BACKGROUND

Trusted applications run in a secure processing environment of a computing device, such as a mobile phone, tablet, or other computing devices. Security researchers and hackers can use automated tools to probe for weaknesses in the trusted applications. Automated test tools allow attackers to quickly exercise functionality critical to maintaining a security boundary. Gaining access to the trusted application can allow the attackers to extend the attack into the kernel of the secure processing environment, which can result in sensitive program code and information stored therein being compromised.

### SUMMARY

An example method for a trusted application operating in a trusted execution environment of a computing device according to the disclosure includes monitoring performance of the trusted application operating in the trusted execution environment of the computing device, determining whether an undesired behavior of the trusted application has occurred more than or equal to a threshold number of times, and executing a delayed restart process for the trusted application.

Implementations of such a method can include one or more of the following features. Determining whether the undesired behavior of the trusted application has occurred more than or equal to the threshold number of times includes determining whether the trusted application has crashed more than or equal to a predetermined number of times within a predetermined period of time. Executing the delayed restart process for the trusted application include preventing the trusted application from restarting until the computing device is rebooted responsive to the trusted application having crashed more than or equal to the predetermined number of times within the predetermined period of time. Executing the delayed restart process for the trusted application include determining a delay period based at least in part in a number of times that the trusted application has crashed within the predetermined period of time responsive to the trusted application not having crashed more than or equal to the predetermined number of times within the predetermined period of time, and preventing the trusted application from restarting until the delay period has elapsed. Determining the delay period include increasing a length of the delay period exponentially based on the number of times that the trusted application has crashed within the predetermined period of time. The method further includes determining the predetermined number of times within the predetermined period of time that the trusted application is expected to crash based on a user configuration input. Monitoring the performance of the trusted application operating in the trusted execution environment of the computing device includes monitoring an interface of the trusted application, and determining whether the undesired behavior of the trusted application has occurred more than or equal to the threshold number of times includes determining whether the interface of the trusted application has been used in an unexpected manner. Determining whether the interface of the trusted application has been used in an unexpected manner includes comparing usage of the interface of the trusted application with expected usage information.

An example apparatus according to the disclosure includes a trusted execution environment comprising a processor and a memory, the processor configured to monitor performance of a trusted application operating in the trusted execution environment, determine whether an undesired behavior of the trusted application has occurred more than or equal to a threshold number of times, and execute a delayed restart process for the trusted application.

Implementations of such an apparatus can include one or more of the following features. The processor being configured to determine whether the undesired behavior of the trusted application has occurred more than or equal to the threshold number of times is further configured to determine whether the trusted application has crashed more than or equal to a predetermined number of times within a predetermined period of time. The processor being configured to execute the delayed restart process for the trusted application to prevent the trusted application from being restarted immediately is further configured to prevent the trusted application from restarting until the apparatus is rebooted responsive to the trusted application having crashed more than or equal to the predetermined number of times within the predetermined period of time. The processor being configured to execute the delayed restart process for the trusted application to prevent the trusted application from being restarted immediately is further configured to determine a delay period based at least in part in a number of times that the trusted application has crashed within the predetermined period of time responsive to the trusted application not having crashed more than or equal to the predetermined number of times within the predetermined period of time, and prevent the trusted application from restarting until the delay period has elapsed. The processor being configured to monitor the performance of the trusted application operating in the trusted execution environment of a computing device is further configured to monitor an interface of the trusted application, and the processor being configured to determine whether the undesired behavior of the trusted application has occurred more than or equal to the threshold number of times is further configured to determine whether the interface of the trusted application has been used in an unexpected manner. The processor being configured to determine whether the interface of the trusted application has been used in an unexpected manner is further configured to compare usage of the interface of the trusted application with expected usage information.

An example non-transitory, computer-readable medium according to the disclosure has stored thereon computer-readable instructions for a trusted application, includes instructions configured to cause a processor of the computing device to monitor performance of the trusted application operating in a trusted execution environment of the computing device, determine whether an undesired behavior of the trusted application has occurred more than or equal to a threshold number of times, and execute a delayed restart process for the trusted application.

Implementations of such a non-transitory, computer-readable medium may include one or more of the following features. The instructions configured to cause the processor to determine whether the undesired behavior of the trusted application has occurred more than or equal to the threshold number of times include instructions configured to cause the processor to determine whether the trusted application has crashed more than or equal to a predetermined number of times within a predetermined period of time. The instructions configured to cause the processor to execute the delayed restart process for the trusted application to prevent the trusted application from being restarted immediately include instructions configured to cause the processor to prevent the trusted application from restarting until the computing device is rebooted responsive to the trusted application having crashed more than or equal to the predetermined number of times within the predetermined period of time. The instructions configured to cause the processor to execute the delayed restart process for the trusted application to prevent the trusted application from being restarted immediately include instructions configured to cause the processor to determine a delay period based at least in part in a number of times that the trusted application has crashed within the predetermined period of time responsive to the trusted application not having crashed more than or equal to the predetermined number of times within the predetermined period of time, and prevent the trusted application from restarting until the delay period has elapsed.

The instructions configured to cause the processor to monitor the performance of the trusted application operating in the trusted execution environment of the computing device include instructions configured to cause the processor to monitor an interface of the trusted application, and the instructions configured to cause the computing device to determine whether the undesired behavior of the trusted application has occurred more than or equal to the threshold number of times include instructions configured to cause the computing device to determine whether the interface of the trusted application has been used in an unexpected manner. The instructions configured to cause the processor to determine whether the interface of the trusted application has been used in an unexpected manner further comprise instructions configured to cause the computing device to compare usage of the interface of the trusted application with expected usage information.

### BRIEF DESCRIPTION OF THE DRAWINGS

FIG. 1 is an example networking environment in which the techniques disclosed herein may be implemented.

FIG. 2 is a functional block diagram of an example secure processing environment in which the techniques disclosed herein may be implemented.

FIG. 3 is a functional block diagram of an example computing device that can be used to implement the techniques disclosed herein.

FIG. 4 is a flow diagram of an example process for mitigating attacks on an application operating in a trusted execution environment of a computing device according to the techniques disclosed herein.

FIG. 5 is a flow diagram of an example process for mitigating attacks on an application operating in a trusted execution environment of a computing device according to the techniques disclosed herein.

FIG. 6 is a flow diagram of an example process for executing a delayed restart process for an application operating in a trusted execution environment of a computing device according to the techniques disclosed herein.

FIG. 7 is a flow diagram of an example process for executing a delayed restart process for an application operating in a trusted execution environment of a computing device according to the techniques disclosed herein.

FIG. 8 is a flow diagram of an example process for executing a delayed restart process for an application operating in a trusted execution environment of a computing device according to the techniques disclosed herein.

FIG. 9 is a flow diagram of an example process for executing a delayed restart process for an application operating in a trusted execution environment of a computing device according to the techniques disclosed herein.

FIG. 10 is a flow diagram of an example process for mitigating attacks on an application operating in a trusted execution environment of a computing device according to the techniques disclosed herein.

### DETAILED DESCRIPTION

Techniques disclosed herein for mitigating attacks on an application operating in a trusted execution environment of a computing device are provided. A trusted application operates within a secure processing environment of a computing device that is isolated from the rich execution environment in which most applications are executed. An attacker may use automated tools to probe for weaknesses in a trusted application that may be exploited to extract information about the trusted application being attacked, other trusted applications in the secure processing environment, and/or sensitive information, such as user information, encryption keys, and/or other information stored in the secure processing environment. The information collected from the attacks may also be used to breach the security of the secure processing environment itself, which may allow the attacker to obtain information that may be used to compromise the secure processing environments of other computing devices. The techniques disclosed herein can mitigate such attacks by monitoring the behavior of a trusted application and by executing a delayed restart process that can halt the execution of the trusted application (if the application is still running) and introduce a delay before the trusted application can be restarted responsive to certain behavior occurring more than or equal to a predetermined number of times. The example processes and apparatuses discussed below illustrate these techniques.

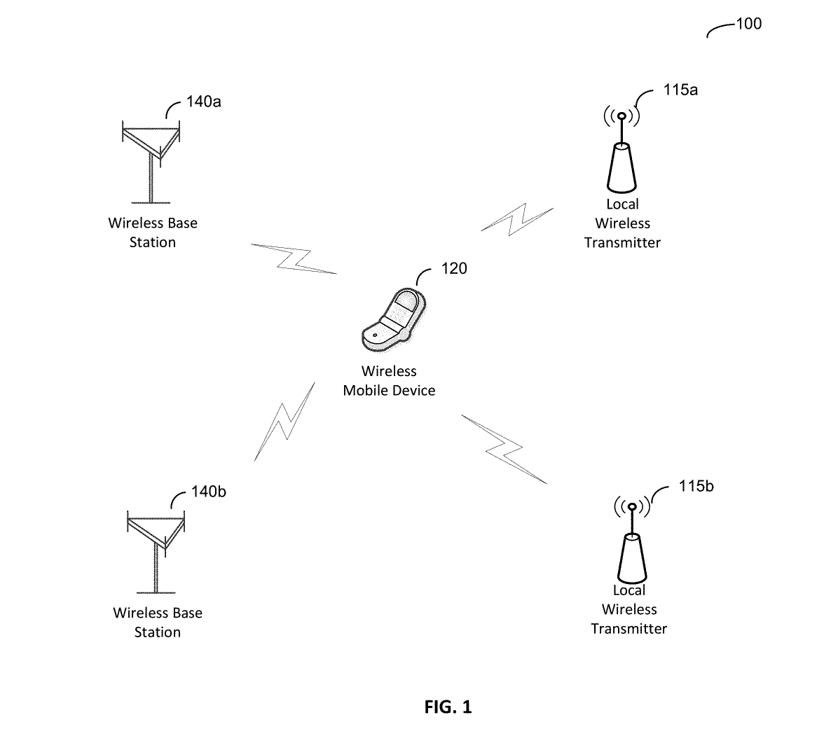

FIG. 1 is a block diagram of an example network architecture, which may be suitable for implementing the techniques discussed herein. The particular configuration illustrated herein is merely an example of one network configuration in which the techniques disclosed herein may be used. Furthermore, an implementation of such a network architecture may include additional elements that are not illustrated herein and have been omitted for the sake of clarity. The example network architecture provides an example of a network environment in which a computing device in which the techniques disclosed herein may be implemented can operate.

The computing device 120 can be a mobile communication device referred to as a User Equipment (UE), a mobile station, a terminal, an access terminal, a subscriber unit, a station, etc. The computing device 120 can be a smartphone, a tablet computer, a laptop computer, game console, wearable device (such as a smart watch) or other device that includes a wireless transmitter that is configured to communicate using one or more wireless communications protocols, including, but not limited to, the Long Term Evolution (LTE), WLAN, and WiMAX wireless communications protocols. The computing device 120 can also be configured to support other types of wireless or wired communications protocols and can be configured to support multiple different wireless communications protocols. The wireless transmitter of the computing device 120 can be configured to send data to and/or receive data from other mobile wireless devices, the wireless transmitters 115, and/or one or more wireless base stations 140.

Each of the wireless transmitters 115 can comprise a wireless local area network (WLAN) wireless access point configured to operate using the IEEE 802.11 wireless communication standards. But, in some implementations some or all of the wireless transmitters 115 may be configured to utilize other wireless communications protocols, and some network environments may include more than one type of wireless transmitter. Furthermore, while the wireless transmitters 115 are identified as transmitters, the wireless transmitters 115 may be transceivers configured to send and/or receive data wirelessly. The wireless transmitters 115 can be connected to a network via a backhaul connection that provides a broadband connection to the network. The network may be the Internet and/or a combination of one or more networks. For example, the wireless transmitter (such as one of the wireless transmitters 115) may be connected to a Digital Subscriber Line (DSL) modem or a cable modem, depending upon the type of broadband service being used in that particular implementation. A wireless transmitter (such as one of the wireless transmitters 115) can be associated with a mobile communication network provider and can be configured to communicate with the mobile communication network provider's network (not shown). The coverage area of a wireless transmitter (such as one of the wireless transmitters 115) may overlap with that of one or more macrocell base stations, such as wireless base stations 140, or that of one or more other terrestrial transceivers.

The wireless base station of the wireless base stations 140 can be configured to provide wireless network connectivity to a plurality of wireless devices, such as computing device 120. The wireless base station can comprise a macrocell base station, a femtocell base station, a picocell base station, or other type of base station. The wireless base station may have a much larger coverage area than the wireless transmitter (such as one of the wireless transmitters 115) or may be a terrestrial transceiver that provides a coverage area that is of a similar size or of a smaller size than the coverage area provided by the wireless transmitters 115. The wireless base station can be configured to communicate using one or more wireless communications protocols. While the example illustrated in FIG. 1 includes on a single wireless base station, in other implementations the network environment is likely to include more than wireless base station which have coverage areas that may overlap at least in part.

The example network configuration illustrated in FIG. 1 is merely an example of one possible configuration of a network in which the techniques disclosed herein may be implemented. Other network configurations may include additional elements not illustrated in FIG. 1 and the various components may be interconnected in a different configuration than what is shown in FIG. 1. Furthermore, while the example computing device 120 illustrated in FIG. 1 is a mobile wireless device, the computing device 120 can comprise a computing device that is stationary or relatively stationary, such as a desktop computing device, a server, a cable box, a DVR, or other computing device that is stationary or relatively stationary. Furthermore, the computing device 120 may utilized wired network connections instead of or in addition to the wireless connections discussed above.

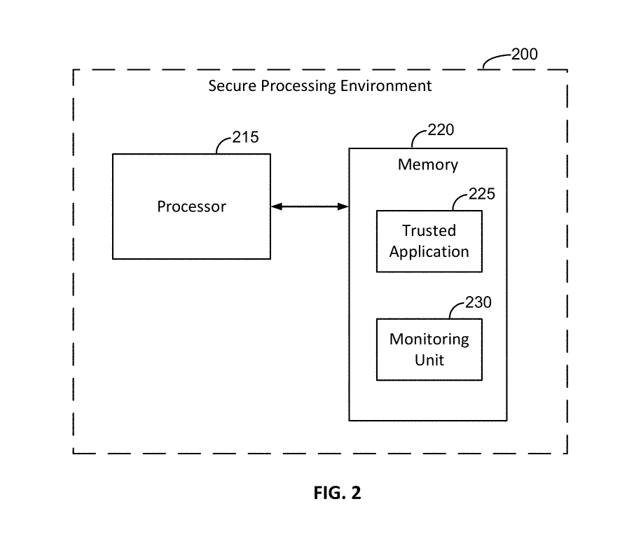

FIG. 2 is a functional block diagram of an example secure processing environment 200 that can be implemented by the computing device 120. The secure processing environment 200 can include a processor 215 and a memory 220. The processor 215 can be coupled to storage media, such as the memory 220 for storing data and software instructions for executing programmed functionality within the mobile device. The memory 220 can be on-board the processor 215 (e.g., within the same IC package), and/or the memory can be external memory to the processor 215 and functionally coupled over a data bus. The memory 220 can comprise volatile memory, a non-volatile memory, or a combination thereof

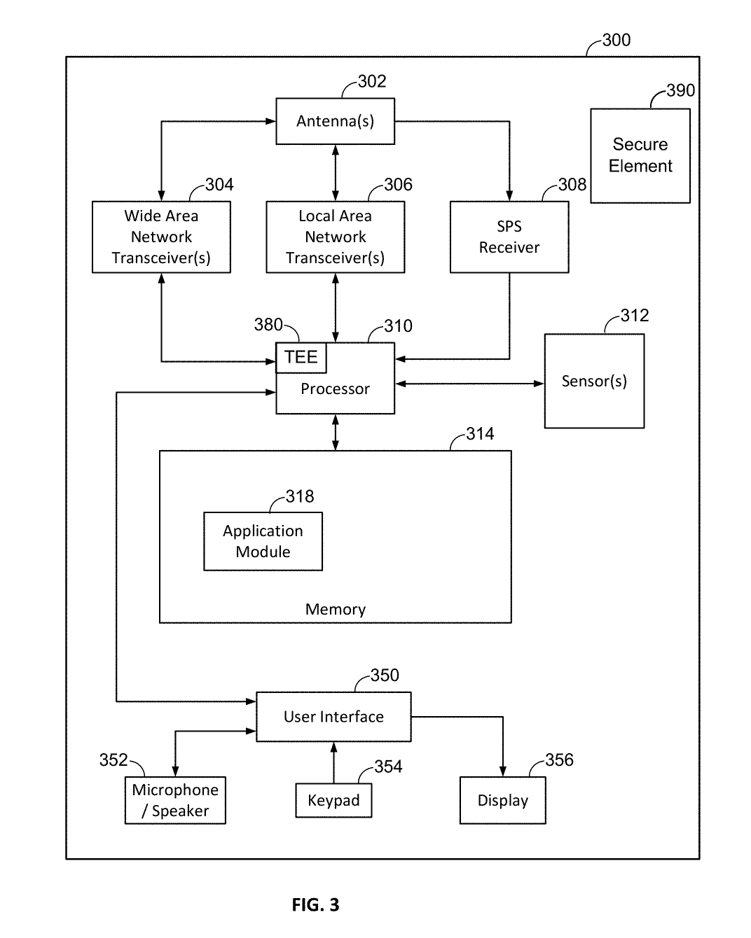

The secure processing environment 200 provides a trusted environment for executing trusted applications and for store sensitive data that is isolated from a rich execution environment of the computing device 120 in which general purpose processing for non-trusted applications may be executed. The secure processing environment 200 can provide confidentiality, integrity, and protection for the trusted applications and the data stored therein. The processor 215 can be configured to execute a trusted application 225, which may be stored as program code in the memory 220. As discussed in more detail below with respect to FIG. 3, the secure processing environment 200 can be implemented as a trusted execution environment that is secure portion of a general purpose processor of the computing device 120 or can be implemented as a secure element that is separate from the general purpose processor of the computing device 120.

The secure processing environment 200 can also include a monitoring unit 230 that is configured to perform the various techniques disclosed herein for monitoring the execution of trusted applications, such as the trusted application 225, and for mitigating attacks on the trusted applications. In the example illustrated in FIG. 2, the secure processing environment only includes a single trusted application, but other implementations can include more than one trusted application that can be monitored by the monitoring unit 230. The monitoring unit 230 can be implemented as a trusted application comprising program code executable by the processor 215 and stored in the memory 220. In other implementations, the monitoring unit 230 can be implemented in hardware, such as one or more application specific integrated circuits (ASICs), programmable logic devices (PLDs), field programmable gate arrays (FPGAs), or other electronic units designed to perform the functions described herein, or a combination thereof

FIG. 3 is a functional block diagram of an example computing device 300 that can be used to implement the computing device 120 illustrated in FIG. 1. FIG. 3 is a schematic diagram illustrating various components of an example computing device 300, which can be similar to or the same as the computing device 120 depicted in FIG. 1. For the sake of simplicity, the various features/components/functions illustrated in the schematic boxes of FIG. 3 are connected together using a common bus to represent that these various features/components/functions are operatively coupled together. Other connections, mechanisms, features, functions, or the like, can be provided and adapted as necessary to operatively couple and configure a portable wireless device. Furthermore, one or more of the features or functions illustrated in the example of FIG. 3 can be further subdivided, or two or more of the features or functions illustrated in FIG. 3 can be combined. Additionally, one or more of the features or functions illustrated in FIG. 3 can be excluded.

As shown, the computing device 300 can include one or more local area network transceivers 306 that can be connected to one or more antennas 302. The one or more local area network transceivers 306 comprise suitable devices, circuits, hardware, and/or software for communicating with and/or detecting signals to/from one or more of the WLAN access points, and/or directly with other wireless devices within a network. In some embodiments, the local area network transceiver(s) 306 can comprise a WiFi (802.11x) communication transceiver suitable for communicating with one or more wireless access points; however, in some embodiments, the local area network transceiver(s) 306 can be configured to communicate with other types of local area networks, personal area networks (e.g., Bluetooth® wireless technology networks), etc. Additionally, any other type of wireless networking technologies can be used, for example, Ultra Wide Band, ZigBee, wireless USB, etc.

The computing device 300 can also include, in some implementations, one or more wide area network transceiver(s) 304 that can be connected to the one or more antennas 302. The wide area network transceiver 304 can comprise suitable devices, circuits, hardware, and/or software for communicating with and/or detecting signals from one or more of, for example, the WWAN access points and/or directly with other wireless devices within a network. In some implementations, the wide area network transceiver(s) 304 can comprise a CDMA communication system suitable for communicating with a CDMA network of wireless base stations. In some implementations, the wireless communication system can comprise other types of cellular telephony networks, such as, for example, TDMA, GSM, WCDMA, LTE etc. Additionally, any other type of wireless networking technologies can be used, including, for example, WiMax (802.16), etc.

In some embodiments, an SPS receiver (also referred to as a global navigation satellite system (GNSS) receiver) 308 can also be included with the computing device 300. The SPS receiver 308 can be connected to the one or more antennas 302 for receiving satellite signals. The SPS receiver 308 can comprise any suitable hardware and/or software for receiving and processing SPS signals. The SPS receiver 308 can request information as appropriate from the other systems, and can perform the computations necessary to determine the position of the computing device 300 using, in part, measurements obtained by any suitable SPS procedure. Some implementations of the computing device 300 may not include an SPS receiver. Furthermore, while the computing device 300 may include an SPS receiver, the computing device 300 may be positioned in a location where the signals from the SPS satellites are obstructed and a time fix from the SPS system cannot be obtained in order to determine and correct for any inaccuracies in the frequency of the crystal oscillator.

As further illustrated in FIG. 3, the example computing device 300 includes one or more sensors 312 coupled to a controller/processor 310. For example, the sensors 312 can include motion sensors to provide relative movement and/or orientation information (which is independent of motion data derived from signals received by the wide area network transceiver(s) 304, the local area network transceiver(s) 306, and/or the SPS receiver 308). By way of example but not limitation, the motion sensors can include an accelerometer, a gyroscope, and a geomagnetic (magnetometer) sensor (e.g., a compass), any of which can be implemented based on micro-electro-mechanical-system (MEMS), or based on some other technology. The motion sensor can be used to identify vibrations and/or other motions that may impact the accuracy of the crystal oscillator of the computing device. The one or more sensors 312 can further include, a thermometer (e.g., a thermistor), an audio sensor (e.g., a microphone) and/or other sensors. The one or more sensors 312 can also include a camera (e.g., a charge-couple device (CCD)-type camera, a CMOS-based image sensor, etc.), which can produce still or moving images (e.g., a video sequence) that can be displayed on a user interface device, such as a display or a screen, and that can be further used to determine an ambient level of illumination and/or information related to colors and existence and levels of UV and/or infra-red illumination.

The processor(s) (also referred to as a controller) 310 can be connected to the local area network transceiver(s) 306, the wide area network transceiver(s) 304, the SPS receiver 308 and the one or more sensors 312. The processor can include one or more microprocessors, microcontrollers, and/or digital signal processors that provide processing functions, as well as other calculation and control functionality. The processor 310 can be coupled to storage media (e.g., memory) 314 for storing data and software instructions for executing programmed functionality within the mobile device. The memory 314 can be on-board the processor 310 (e.g., within the same IC package), and/or the memory can be external memory to the processor and functionally coupled over a data bus.

A number of software modules and data tables can reside in memory 314 and can be utilized by the processor 310 in order to manage both communications with remote devices/nodes, perform positioning determination functionality, and/or perform device control functionality. As illustrated in FIG. 3, in some embodiments, the memory 314 can include an application module 318 which can implement one or more applications. It is to be noted that the functionality of the modules and/or data structures can be combined, separated, and/or be structured in different ways depending upon the implementation of the computing device 300.

The application module 318 can be a process running on the processor 310 of the computing device 300, which can request information from the application module 316 or other data from one of the other modules of the computing device 300. Applications typically run within an upper layer of the software architectures and can be implemented in a rich execution environment of the computing device 300.

The processor 310 may include a trusted execution environment 380 and/or the computing device 300 may include a secure element 390 that can implement a secure processing environment. The trusted execution environment 380 and/or the secure element 390 can be used to implement a secure processing environment for executing trusted applications and for storing sensitive data associated with trusted applications. The trusted execution environment 380 can be implemented as a secure area of the processor 310 that can be used to process and store sensitive data in an environment that is segregated from the rich execution environment in which the operating system and/or applications (such as those of the application module 318) may be executed. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, user data, and/or other sensitive data.

The computing device 300 may include a secure element 390 (also referred to herein as a trusted component). The computing device 300 may include the secure element 390 in addition to or instead of the trusted execution environment 380. The secure element 390 can comprise autonomous and tamper-resistant hardware that can be used to execute trusted applications and to provide the confidential data associated with such applications with confidentiality, integrity, and protection. The secure element 390 can be used to store encryption keys, user data, and/or other sensitive data like that which may be stored by the trusted execution environment 380. The secure element 390 can be integrated with the hardware of the computing device 300 in a permanent or semi-permanent fashion or may, in some implementations, be a removable component of the computing device 300 that can be used to securely store data and/or provide a secure execution environment for applications.

The computing device 300 can further include a user interface 350 providing suitable interface systems, such as a microphone/speaker 352, a keypad 354, and a display 356 that allows user interaction with the computing device 300. The microphone/speaker 352 (which can be the same or different from the audio sensor) provides for voice communication services (e.g., using the wide area network transceiver(s) 304 and/or the local area network transceiver(s) 306). The keypad 354 can comprise suitable buttons for user input. The display 356 can include a suitable display, such as, for example, a backlit LCD display, and can further include a touch screen display for additional user input modes.

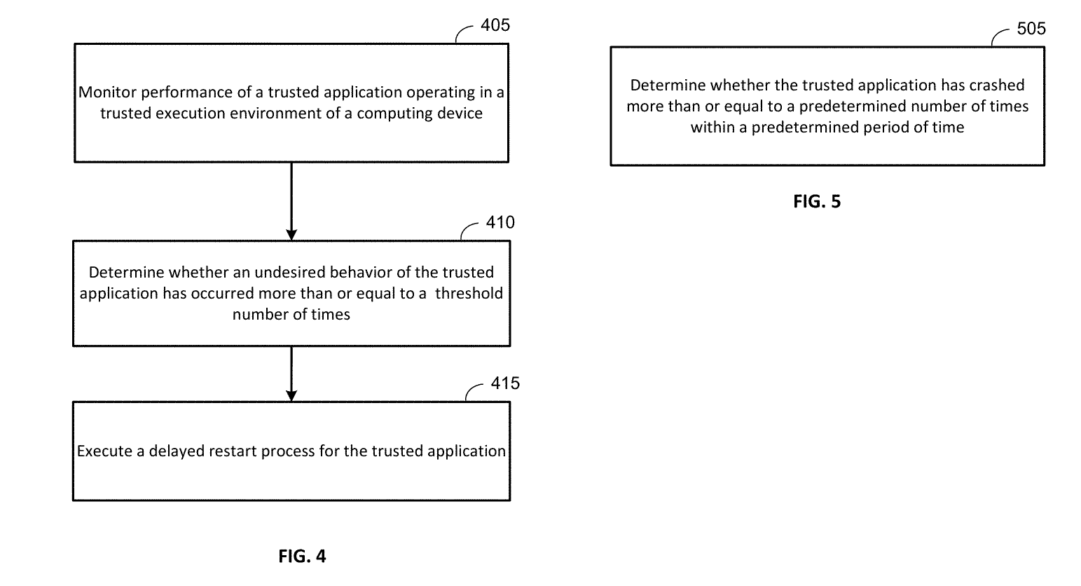

FIG. 4 is a flow diagram of an example process an application operating in a trusted execution environment of a computing device according to the techniques disclosed herein. The process illustrated in FIG. 4 can be implemented by the monitoring unit 230 of the secure processing environment 200 of the computing device 120. The process of FIG. 4 can be used to mitigate attacks on the trusted application.

Performance of a trusted application operating in a trusted execution environment of a computing device can be monitored (stage 405). The monitoring unit 230 of the secure processing environment 200 can be configured to monitor the behavior of the trusted application 225. An attacker may use automated tools to probe for weaknesses in the trusted application 225 that the attacker may be able to use to exploit to gain access to aspects of the kernel of the secure processing environment 200. If the attacker is able to gain access to the kernel of the secure processing environment 200, sensitive data and/or program code stored within the secure processing environment 200 could be compromised, including but not limited to encryption keys, security certificates, sensitive hardware information, and/or sensitive user information. The monitoring unit 230 can be configured to monitor parameters that may be indicative of the trusted application 225 being attacked, using an automated tool or otherwise. For example, the monitoring unit 230 can be configured to monitor how many time that the trusted application crashes, memory usage by the trusted application 225, processor usage by the trusted application 225, frequency at which the trusted application 225 is accessed or launched on the computing device 120. The monitoring unit 230 can be configured to access configuration information stored in the memory 220 of the secure processing environment 200, which can be used to indicate which parameters that the monitoring unit 230 should monitor for which trusted applications. The configuration information can be provided by a device manufacturer, and a developer of the trusted application 225, or other trusted entity, such as a wireless network provider or reseller of the computing device 120. The configuration information may be updated periodically and may be automatically pushed to the computing device 120 by the information provider or may be downloaded by the monitoring unit 230, which can be configured to periodically check for updates to the configuration information. The configuration information can include expected usage information associated with one or more trusted applications, such as the trusted application 125. The expected usage information can define various expected usage parameters associated with a trusted application, such as the how frequently the application is expected to be accessed, how frequently the application is expected to crash, and how an interface of the application is expected to be used.

A determination can be made whether an undesired behavior of the trusted application has occurred more than or equal to a threshold number of times (stage 410). The monitoring unit 230 can be configured to monitor the behavior of the trusted application 225 and to compare the behavior of the trusted application 225 with the expected usage information to determine whether an undesired behavior of the trusted application has occurred more than or equal to a threshold number of times. The expected usage information can define which types of actions or events constitute undesired behavior for the trusted application 225 and a number of times that such an action or event may occur before the monitoring unit 230 takes action. The monitoring unit 230 can make a determination whether one or more of such actions or events occurred the specified number times associated with the respective one or more of such actions or events.

A delayed restart process can be executed for the trusted application (stage 415). The monitoring unit 230 can be configured to halt the execution of the trusted application 225 by the processor 215 if the application has not already crashed or otherwise been halted. The monitoring unit 230 can be configured to implement a delayed restart process that prevents the trusted application from being restarted immediately. Delaying the restart of the application can help to thwart an attack on the trusted application by slowing or halting the attack on the trusted application 225 by preventing the attacker from being able to immediately being probing the trusted application 225 again. The delayed restart process can include introducing an increasingly longer delays between a crash or shutdown of the trusted application 225 and allowing the trusted application 125 to be restarted. The delayed restart process can also include rebooting the computing device 120. The delayed restart process can also include requiring the user of the computing device 120 to enter a pin, password, passcode pattern, or other authentication information before the application can be restarted to prevent an automated attack tool from being able immediately and repeatedly attack the trusted application.

FIG. 5 is a flow diagram of an example process for mitigating attacks on an application operating in a trusted execution environment of a computing device according to the techniques disclosed herein. The process illustrated in FIG. 5 can be implemented by the monitoring unit 230 of the secure processing environment 200 of the computing device 120. The process illustrated in FIG. 5 can be used to implement, at least in part, stage 410 of the process illustrated in FIG. 4.

A determination whether the application has crashed more than or equal to a predetermined number of times within a predetermined period of time (stage 505). The monitoring unit 230 can be configured to monitor how many times that the trusted application has crashed within a predetermined period of time. The expected usage information associated with the trusted application 225 can include a number of times that the application may reasonably be expected to crash within a predetermined period of time. This information may be provided by the application developer or the user of the computing device 120 can impose limits on the number of times that an application may be allowed to crash within a predetermined period of time before the delayed restart process is initiated for the application. An example of such a process is illustrated in FIG. 9. The monitoring unit 230 can be configured to initiate a delayed restart process for the trusted application 225 responsive to the trusted application 225 having crashed more than or equal to the predetermined number of times within the predetermined period of time.

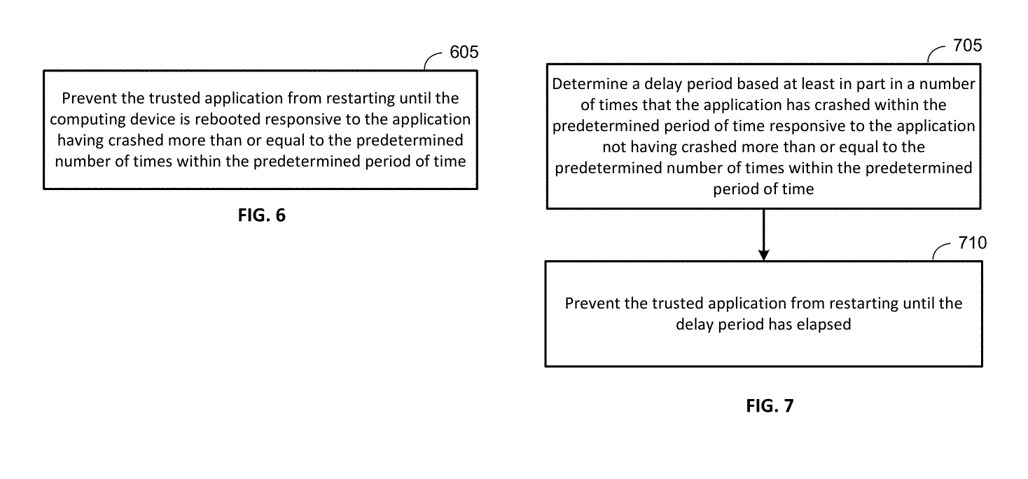

FIG. 6 is a flow diagram of an example process for executing a delayed restart process for an application operating in a trusted execution environment of a computing device according to the techniques disclosed herein. The process illustrated in FIG. 6 can be implemented by the monitoring unit 230 of the secure processing environment 200 of the computing device 120. The process illustrated in FIG. 6 can be used to implement, at least in part, stage 415 of the process illustrated in FIG. 4.

The trusted application can be prevented from restarting until the computing device is rebooted responsive to the application having crashed more than or equal to the predetermined number of times within the predetermined period of time (stage 605). The monitoring unit 230 can be configured to disable the trusted application 225 by setting an indicator associated with the trusted application 225 in the configuration information stored in the memory 220 of the secure processing environment 200 to a “disable until reboot” value. The monitoring unit 230 can be configured to re-enable the trusted application 225 by setting the indicator associated with the trusted application 225 in the configuration information stored in the memory 220 of the secure processing environment 200 to an “enable” value once the computing device 120 has been rebooted. The processor 215 can be configured to determine whether an application is enabled or disabled by reading the indicator before executing the application.

FIG. 7 is a flow diagram of an example process for executing a delayed restart process for an application operating in a trusted execution environment of a computing device according to the techniques disclosed herein. The process illustrated in FIG. 7 can be implemented by the monitoring unit 230 of the secure processing environment 200 of the computing device 120. The process illustrated in FIG. 7 can be used to implement, at least in part, stage 415 of the process illustrated in FIG. 4.

A delay period can be determined based at least in part in a number of times that the application has crashed within the predetermined period of time responsive to the application not having crashed more than or equal to the predetermined number of times within the predetermined period of time (stage 705). The monitoring unit 230 can be configured to determine how long to delay the restart of the trusted application 225 based on the number of time that the trusted application 225 has crashed. The monitoring unit 230 can be configured to introduce delays having an exponentially longer length so that the application cannot be started for a longer period of time each time that the trusted application crashes. The monitoring unit 230 can be configured to increase the length of the delay linearly or by another growth rate instead of an exponential growth rate.

The trusted application can be prevented from restarting until the delay period has elapsed (stage 710). The monitoring unit 230 can be configured to disable the trusted application 225 on the secure processing environment 200 of the computing device 120 until the delay period has elapsed. The monitoring unit 230 can be configured to disable the trusted application 225 by setting an indicator associated with the trusted application 225 in the configuration information stored in the memory 220 of the secure processing environment 200 to a “disable” value. The monitoring unit 230 can be configured to re-enable the trusted application 225 by setting the indicator associated with the trusted application 225 in the configuration information stored in the memory 220 of the secure processing environment 200 to an “enable” value. The processor 215 can be configured to determine whether an application is enabled or disabled by reading the indicator before executing the application. The monitoring unit can be configured to automatically relaunch the application after the delay period has elapsed or can be configured to allow a user of the computing device 120 to restart the application if desired.

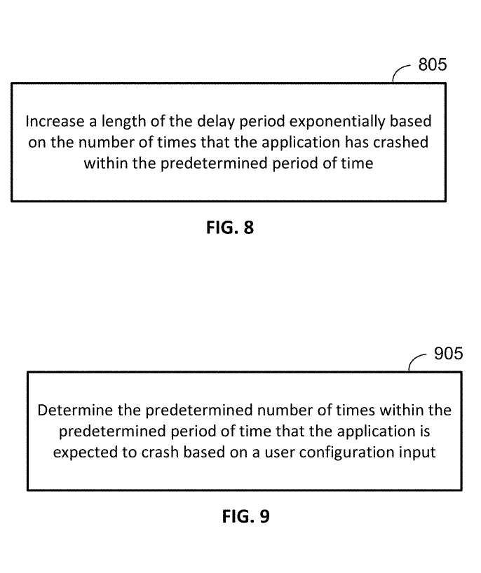

FIG. 8 is a flow diagram of an example process for executing a delayed restart process for an application operating in a trusted execution environment of a computing device according to the techniques disclosed herein. The process illustrated in FIG. 4 can be implemented by the monitoring unit 230 of the secure processing environment 200 of the computing device 120. The process illustrated in FIG. 8 can be used to implement, at least in part, stage 705 of the process illustrated in FIG. 7.

A length of the delay period can be increased exponentially based on the number of times that the application has crashed within the predetermined period of time (stage 805). The monitoring unit 230 can be configured to exponentially increase the length of the delay between detecting a crash of the trusted application 225 and permitting the trusted application to be restarted. The length of the delay can be increased exponentially for each crash, such that the more times the trusted application 225 has crashed, the longer the length of the delay that is introduced before the application may be restarted. Such an exponential back off can make it prohibitively difficult for an attacker to induce a trusted application 225 to repeatedly crash in an attempt to extract information about or from the trusted application 225 and/or the secure processing environment 200 of the computing device 120. The monitoring unit 230 can be configured to reset the length of the delay and/or the counts of the number of times that the application has crashed in response to the computing device 120 being rebooted. Rebooting the computing device 129 should halt any malicious program code that is being executed by the computing device 120 and can introduce significant delays that can thwart an attacker from making continued repeated attacks on the trusted application 225.

FIG. 9 is a flow diagram of an example process for executing a delayed restart process for an application operating in a trusted execution environment of a computing device according to the techniques disclosed herein. The process illustrated in FIG. 9 can be implemented by the monitoring unit 230 of the secure processing environment 200 of the computing device 120. The process illustrated in FIG. 9 can be used to implement, at least in part, stage 415 of the process illustrated in FIG. 4.

A user input indicative of an expected number of times that the application is expected to crash within the predetermined period of time can be received (stage 805). The monitoring unit 230 can be configured to receive an input from a user that indicates an expected number of times that an application is expected to crash or is permitted to crash within a predetermined period of time before a delayed restart process is implemented by the monitoring unit 230. The monitoring unit 230 can be configured to provide a developer mode that can be accessed by application developers that are testing their applications. The monitoring unit 230 can provide a user interface that allows a developer to configure or turn off the delayed restart process while the application is under development to prevent the delayed restart process from impeding application testing. The monitoring unit 230 can be configured to require authentication credentials from the developer that allows the developer access to the developer mode. The computing device 120 can also be configured as a developer version of the computing device 120 in which the monitoring unit 230 is configured to operate in a developer mode responsive to the developer providing the required authentication credentials and the developer mode may not be included in the version of the computing device 120 produced for end-user consumption.

The monitoring unit 230 can also be configured to provide a user interface that allows an end-user of the computing device 120 to configure the monitoring unit 230 to apply more restrictive criteria that that defined in the configuration information provided by the manufacturer or other trusted entity. For example, the configuration information may specify that a particular application may crash more than or equal to a predetermined number of times within a predetermined period of time before the delayed restart process is initiated, but the end-user may override the predetermined number of times value with a smaller number to cause the monitoring unit 230 to initiate the delayed restart process in response to fewer crashes than would have been required according to the configuration information stored in the memory 220. The user can also impose stricter responses to the undesired behavior than what is defined in the configuration information stored in the memory 220. For example, the user may indicate that the application should be disabled until a reboot rather than imposing a delay before the application can restart.

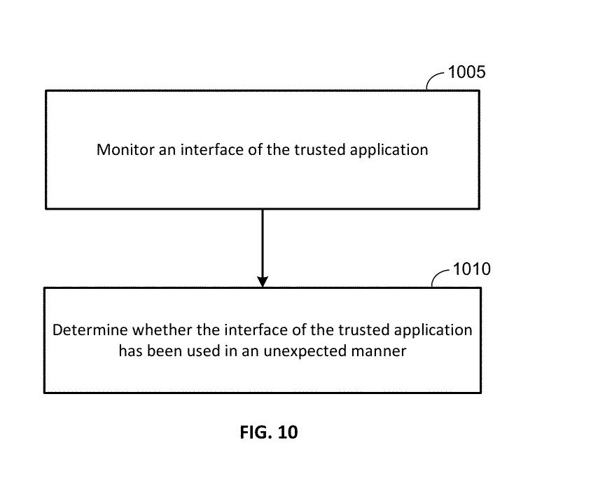

FIG. 10 is a flow diagram of an example process for mitigating attacks on an application operating in a trusted execution environment of a computing device according to the techniques disclosed herein. The process illustrated in FIG. 10 can be implemented by the monitoring unit 230 of the secure processing environment 200 of the computing device 120. The process illustrated in FIG. 10 can be used to implement, at least in part, stages 410 and 415 of the process illustrated in FIG. 4.

An interface of the trusted application can be monitored (stage 1005). The monitoring unit 230 can be configured to monitor one or more interfaces of the computing device 120 to determine whether the interface has been used in an unexpected manner. The monitoring unit 230 can be configured to monitor a user interface of the trusted application 225. User interactions with the user interface of the trusted application 225, such as user inputs via a touchscreen, keyboard, mouse, motion sensors, and/or other inputs device can be monitored. An attacker may attempt to induce a crash of the trusted application 225 by overwhelming the application with inputs from one or more input sources. The monitoring unit 230 can also be configured to monitor commands entered into the application (e.g., load data and save data). An attacker may attempt to crash the trusted application 225 by rapidly entering a series of commands and/or by attempting to load bad or corrupted data. The monitoring unit 230 can be configured to monitor the commands issued to the trusted application. The monitoring unit 230 can also be configured to monitor an application programming interface (API) provided by the trusted application 225 that enables other applications and/or the operating system of the computing device 120 to interact with the trusted application 225.

A determination can be made whether the interface of the trusted application has been unused in an unexpected manner (stage 1010). The monitoring unit 230 can be configured to monitor the usage of the one or more interfaces of the trusted application 225 and to compare the usage of the one or more interfaces of the trusted application 225 with expected usage information to determine whether an undesired usage of the trusted application has occurred more than or equal to a predetermined number of times. The expected usage information can define which types of actions or events constitute undesired usage for the trusted application 225 and a number of times that such an action or event may occur before the monitoring unit 230 takes action. The monitoring unit 230 can make a determination whether one or more of such actions or events occurred the specified number times associated with the respective one or more of such actions or events.

The methodologies described herein may be implemented by various means depending upon the application. For example, these methodologies may be implemented in hardware, firmware, software, or any combination thereof For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for a trusted application operating in a trusted execution environment of a computing device, the method comprising:
monitoring performance of the trusted application operating in the trusted execution environment of the computing device;
determining whether an undesired behavior of the trusted application has occurred more than or equal to a threshold number of times; and
executing a delayed restart process for the trusted application.

2. The method of claim 1, wherein determining whether the undesired behavior of the trusted application has occurred more than or equal to the threshold number of times further comprises:
determining whether the trusted application has crashed more than or equal to a predetermined number of times within a predetermined period of time.

3. The method of claim 2, wherein executing the delayed restart process for the trusted application further comprises:
preventing the trusted application from restarting until the computing device is rebooted responsive to the trusted application having crashed more than or equal to the predetermined number of times within the predetermined period of time.

4. The method of claim 2, wherein executing the delayed restart process for the trusted application further comprises:
determining a delay period based at least in part in a number of times that the trusted application has crashed within the predetermined period of time responsive to the trusted application not having crashed more than or equal to the predetermined number of times within the predetermined period of time; and
preventing the trusted application from restarting until the delay period has elapsed.

5. The method of claim 4, wherein determining the delay period further comprises increasing a length of the delay period exponentially based on the number of times that the trusted application has crashed within the predetermined period of time.

6. The method of claim 5, further comprising determining the predetermined number of times within the predetermined period of time that the trusted application is expected to crash based on a user configuration input.

7. The method of claim 1, wherein monitoring the performance of the trusted application operating in the trusted execution environment of the computing device further comprises monitoring an interface of the trusted application, and wherein determining whether the undesired behavior of the trusted application has occurred more than or equal to the threshold number of times comprises determining whether the interface of the trusted application has been used in an unexpected manner.

8. The method of claim 7, wherein determining whether the interface of the trusted application has been used in an unexpected manner comprises comparing usage of the interface of the trusted application with expected usage information.

9. An apparatus comprising:
a trusted execution environment comprising a processor and a memory, the processor configured to
monitor performance of a trusted application operating in the trusted execution environment;
determine whether an undesired behavior of the trusted application has occurred more than or equal to a threshold number of times; and
execute a delayed restart process for the trusted application.

10. The apparatus of claim 9, wherein the processor being configured to determine whether the undesired behavior of the trusted application has occurred more than or equal to the threshold number of times is further configured to:
determine whether the trusted application has crashed more than or equal to a predetermined number of times within a predetermined period of time.

11. The apparatus of claim 10, wherein the processor being configured to execute the delayed restart process for the trusted application to prevent the trusted application from being restarted immediately is further configured to:
prevent the trusted application from restarting until the apparatus is rebooted responsive to the trusted application having crashed more than or equal to the predetermined number of times within the predetermined period of time.

12. The apparatus of claim 10, wherein the processor being configured to execute the delayed restart process for the trusted application to prevent the trusted application from being restarted immediately is further configured to:
determine a delay period based at least in part in a number of times that the trusted application has crashed within the predetermined period of time responsive to the trusted application not having crashed more than or equal to the predetermined number of times within the predetermined period of time; and
prevent the trusted application from restarting until the delay period has elapsed.

13. The apparatus of claim 9, wherein the processor being configured to monitor the performance of the trusted application operating in the trusted execution environment of a computing device is further configured to monitor an interface of the trusted application, and wherein the processor being configured to determine whether the undesired behavior of the trusted application has occurred more than or equal to the threshold number of times is further configured to determine whether the interface of the trusted application has been used in an unexpected manner.

14. The apparatus of claim 13, wherein the processor being configured to determine whether the interface of the trusted application has been used in an unexpected manner is further configured to compare usage of the interface of the trusted application with expected usage information.

15. An non-transitory, computer-readable medium, having stored thereon computer-readable instructions for mitigating attacks on applications operating in a trusted execution environment of a computing device, comprising instructions configured to cause a processor of the computing device to:
monitor performance of a trusted application operating in the trusted execution environment of the computing device;
determine whether an undesired behavior of the trusted application has occurred more than or equal to a threshold number of times; and
execute a delayed restart process for the trusted application.

16. The non-transitory, computer-readable medium of claim 15, wherein the instructions configured to cause the processor to determine whether the undesired behavior of the trusted application has occurred more than or equal to the threshold number of times further comprise instructions configured to cause the processor to:
determine whether the trusted application has crashed more than or equal to a predetermined number of times within a predetermined period of time.

17. The non-transitory, computer-readable medium of claim 16, wherein the instructions configured to cause the processor to execute the delayed restart process for the trusted application to prevent the trusted application from being restarted immediately further comprise instructions configured to cause the processor to:
prevent the trusted application from restarting until the computing device is rebooted responsive to the trusted application having crashed more than or equal to the predetermined number of times within the predetermined period of time.

18. The non-transitory, computer-readable medium of claim 16, wherein the instructions configured to cause the processor to execute the delayed restart process for the trusted application to prevent the trusted application from being restarted immediately further comprise instructions configured to cause the processor to:
determine a delay period based at least in part in a number of times that the trusted application has crashed within the predetermined period of time responsive to the trusted application not having crashed more than or equal to the predetermined number of times within the predetermined period of time; and
prevent the trusted application from restarting until the delay period has elapsed.

19. The non-transitory, computer-readable medium of claim 15, wherein the instructions configured to cause the processor to monitor the performance of the trusted application operating in the trusted execution environment of the computing device further comprise instructions configured to cause the processor to monitor an interface of the trusted application, and wherein the instructions configured to cause the computing device to determine whether the undesired behavior of the trusted application has occurred more than or equal to the threshold number of times further comprise instructions configured to cause the computing device to determine whether the interface of the trusted application has been used in an unexpected manner.

20. The non-transitory, computer-readable medium of claim 19, wherein the instructions configured to cause the computing device to determine whether the interface of the trusted application has been used in an unexpected manner further comprise instructions configured to cause the computing device to compare usage of the interface of the trusted application with expected usage information.
